(19) United States
(12) Patent Application Publication
(10) Pub. No.: US 2026/0039050 A1
(43) Pub. Date: Feb. 5, 2026

(54) CABLE CONNECTOR WITH IMPROVED OVER-MOLDING HOUSING AND COVER PLATE

(71) Applicant: DONGGUAN LUXSHARE TECHNOLOGIES CO., LTD, Dongguan City (CN)

(72) Inventors: Sihai YI, Dongguan City (CN); Zhaolong ZENG, Dongguan City (CN); Kaide WANG, Dongguan City (CN)

(73) Assignee: DONGGUAN LUXSHARE TECHNOLOGIES CO., LTD, Dongguan City (CN)

(21) Appl. No.: 19/205,176

(22) Filed: May 12, 2025

(30) Foreign Application Priority Data
Aug. 5, 2024 (CN) 202411069084.4

(51) Int. Cl. H01R 13/50; H01R 13/66

(52) U.S. Cl. CPC H01R 13/50; H01R 13/665

(57) ABSTRACT

A cable connector includes an electrical connector, a built-in adapter circuit board, a number of cables, an over-molding housing and a cover plate. The electrical connector includes a body and a conductive terminal. The body includes a mating slot and an installation space. The conductive terminal includes a mating portion extending into the mating slot and a tail portion extending into the installation space. The built-in adapter circuit board includes a first area electrically connected to the tail portions and a second area electrically connected to the cables. The over-molding housing is configured to improve the structural strength of the cable connector. The cover plate is installed on the body and/or the over-molding housing to facilitate maintenance of the built-in adapter circuit board.

### CROSS-REFERENCE TO RELATED APPLICATION

This patent application claims priority of a Chinese Patent Application No. 202411069084.4, filed on Aug. 5, 2024 and titled “CABLE CONNECTOR”, the entire content of which is incorporated herein by reference.

### TECHNICAL FIELD

The present disclosure relates to a cable connector, which belongs to the technical field of connectors.

### BACKGROUND

Cable connectors in the related art usually include an electrical connector, a built-in adapter circuit board electrically connected to the electrical connector, and a plurality of cables electrically connected to the built-in adapter circuit board. In order to increase the structural strength of the cable connector, the cable connector further includes an over-molding block over-molded on the built-in adapter circuit board. The over-molding block covers at least part of the electronic components of the built-in adapter circuit board during molding.

However, although the over-molding block in the related art is beneficial to increasing the structural strength, it is easy to cause impact to the electronic components during molding of the over-molding block, thereby causing damage to the electronic components. Besides, with the over-molding block design in the related art, once the electronic components embedded in the over-molding block are damaged, they cannot be repaired, and the maintainability is poor.

### SUMMARY

An object of the present disclosure is to provide a cable connector with improved structural strength and easy maintenance.

In order to achieve the above object, the present disclosure adopts the following technical solution: a cable connector, including: an electrical connector, the electrical connector including a body and a plurality of conductive terminals provided on the body, the body including a mating surface, an installation end surface disposed opposite to the mating surface, a mating slot extending through the mating surface along a first direction, and an installation space located outside the installation end surface along a second direction opposite to the first direction; each conductive terminal including a mating portion extending into the mating slot and a tail portion extending beyond the installation end surface and extending into the installation space; a built-in adapter circuit board, the built-in adapter circuit board being at least partially installed in the installation space; the built-in adapter circuit board including a first area and a second area; the first area being electrically connected to the tail portions of the plurality of conductive terminals; a plurality of cables, the plurality of cables being electrically connected to the second area; an over-molding housing, the over-molding housing being over-molded on the second area to cover a connection position between the plurality of cables and the second area; and a cover plate, the cover plate being installed on the body and/or the over-molding housing along a third direction so as to cover at least one side of the installation space; the third direction being perpendicular to the first direction and the second direction.

In order to achieve the above object, the present disclosure adopts the following technical solution: a cable connector, including: an electrical connector, the electrical connector including a body and a plurality of conductive terminals provided on the body, the body including a mating surface, an installation end surface disposed opposite to the mating surface, a mating slot extending through the mating surface along a first direction, and an installation space extending along a second direction opposite to the first direction; each conductive terminal including a mating portion extending into the mating slot and a tail portion extending into the installation space; a built-in adapter circuit board, the built-in adapter circuit board being at least partially installed in the installation space; the built-in adapter circuit board including a first area and a second area; the first area being electrically connected to the tail portions of the plurality of conductive terminals; a plurality of cables, the plurality of cables being electrically connected to the second area; an over-molding housing, the over-molding housing being over-molded on the second area to cover a connection position between the plurality of cables and the second area; and a cover plate, the cover plate being detachably installed on the body and/or the over-molding housing along a third direction so as to cover at least one side of the installation space; the third direction being perpendicular to the first direction and the second direction.

Compared with the prior art, the cable connector of the present disclosure includes the over-molding housing and the cover plate. The over-molding housing is over-molded on the second area so as to cover the connection position between the cables and the second area, thereby improving the structural strength of the cable connector. The cover plate is installed on the body and/or the over-molding housing along the third direction to cover at least one side of the installation space, which facilitates maintenance of a portion of the built-in adapter circuit board covered by the cover plate when removing the cover plate.

### BRIEF DESCRIPTION OF DRAWINGS

FIG. 1 is a schematic perspective view of a cable connector in accordance with an embodiment of the present disclosure;

FIG. 2 is a perspective view of FIG. 1 from another angle;

FIG. 3 is a partially exploded perspective view of FIG. 1, in which a first cover plate and a second cover plate are separated;

FIG. 4 is a partially exploded perspective view of FIG. 3 from another angle;

FIG. 5 is a further partial perspective exploded view of the cable connector in FIG. 3 after removing the first cover plate and the second cover plate, in which an over-molding housing is separated;

FIG. 6 is a partially exploded perspective view of FIG. 5 from another angle;

FIG. 7 is a further partially exploded perspective view of FIG. 5;

FIG. 8 is an exploded perspective view of FIG. 7 from another angle;

FIG. 9 is an exploded perspective view of FIG. 7 from yet another angle;

FIG. 10 is a further partially exploded perspective view of FIG. 7;

FIG. 11 is a partially exploded perspective view of FIG. 10;

FIG. 12 is a top view of the cable connector in accordance with the embodiment of the present disclosure in an exploded state;

FIG. 13 is a bottom view of the cable connector in accordance with the embodiment of the present disclosure in the exploded state;

FIG. 14 is a side view of the cable connector in accordance with the embodiment of the present disclosure in the exploded state; and

FIG. 15 is a schematic cross-sectional view taken along line B-B in FIG. 1.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

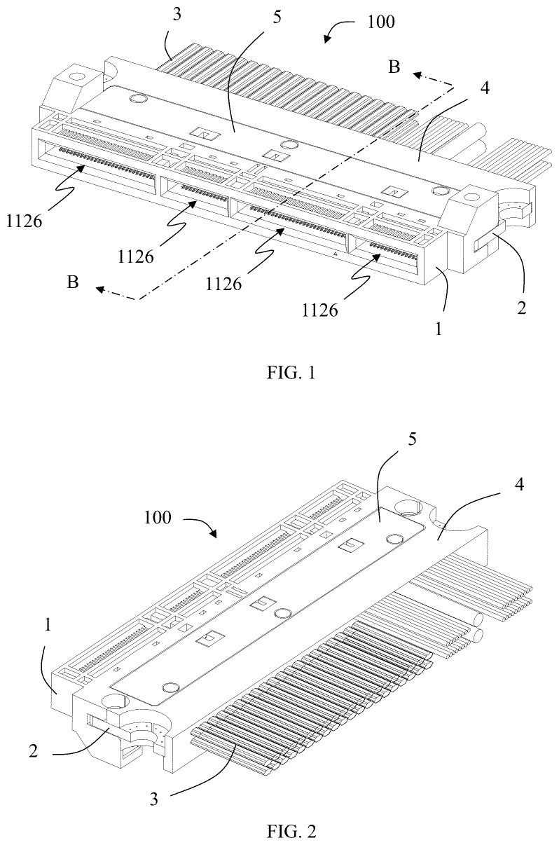

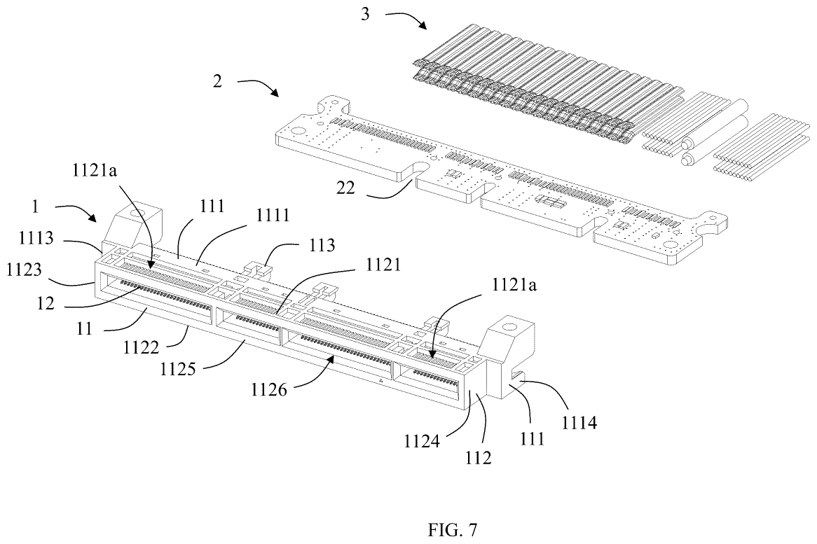

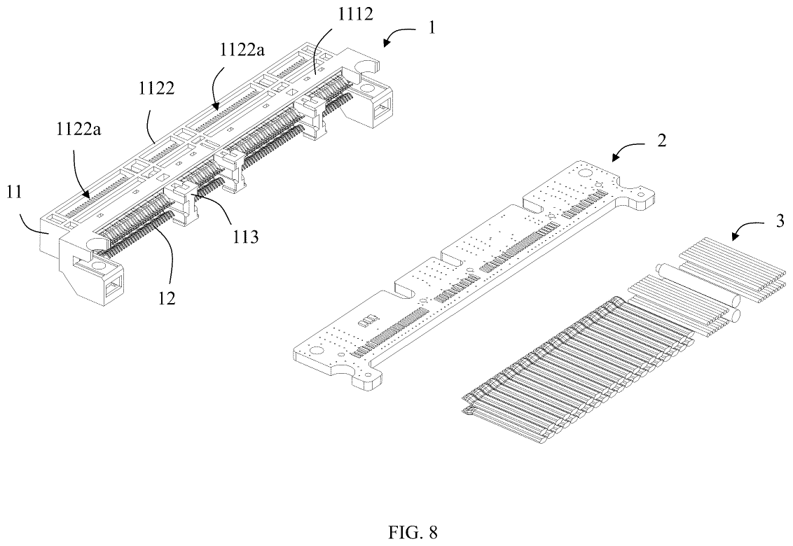

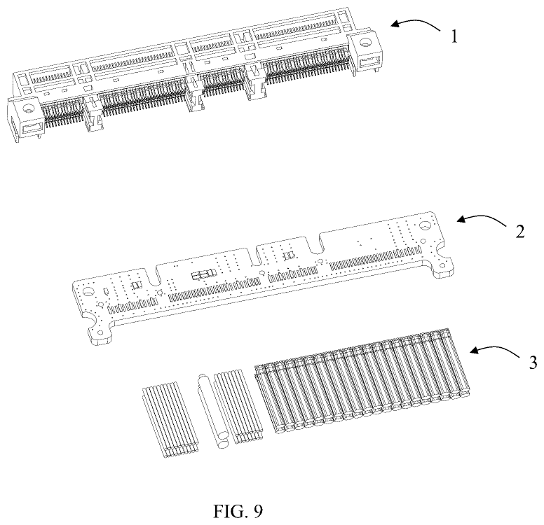

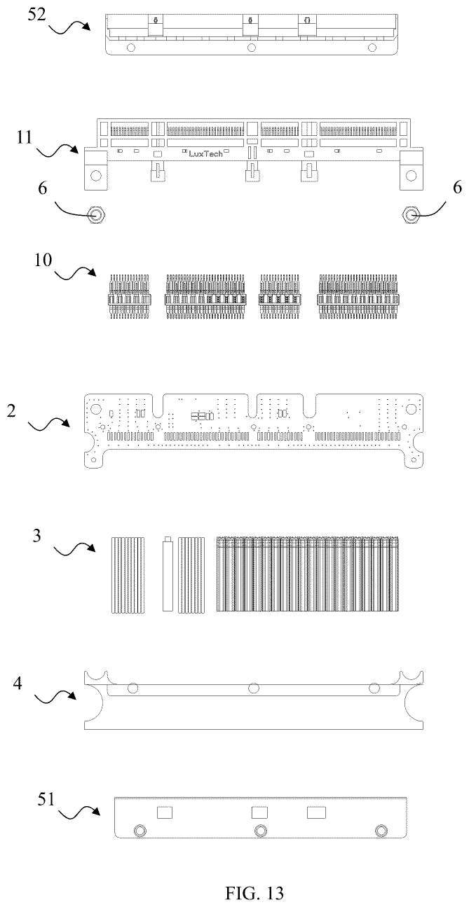

Referring to FIG. 1 to FIG. 15, the present disclosure discloses a cable connector 100, which includes an electrical connector 1, a built-in adapter circuit board 2 at least partially mounted to the electrical connector 1 and electrically connected to the electrical connector 1, a plurality of cables 3 electrically connected to the built-in adapter circuit board 2, an over-molding housing 4 over-molded on part of the built-in adapter circuit board 2, and a cover plate 5 detachably installed on the electrical connector 1 and/or the over-molding housing 4.

In the illustrated embodiment of the present disclosure, the electrical connector 1 includes a body 11 and a plurality of conductive terminals 12 provided on the body 11.

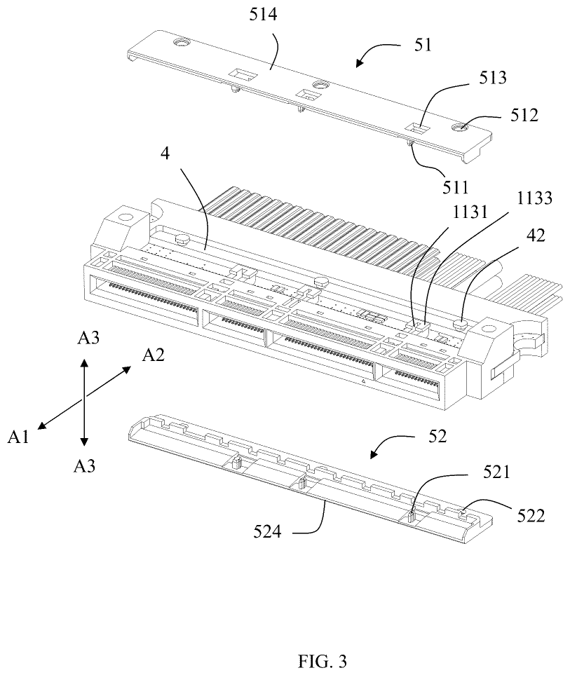

Referring to FIG. 3 to FIG. 9, in one embodiment of the present disclosure, the body 11 is an insulating body, that is, the body 11 is made of insulating material. The body 11 includes a base portion 111, a mating protrusion 112 extending from the base portion 111 along a first direction A1 (for example, a back-to-front direction), and a plurality of extending protrusions 113 extending from the base portion 111 along a second direction A2 (for example, a front-to-back direction). In the illustrated embodiment of the present disclosure, the base portion 111, the mating protrusion 112 and the extending protrusions 113 are integrally formed. The first direction A is opposite to the second direction A2.

The mating protrusion 112 includes a first top wall 1121, a first bottom wall 1122 opposite to the first top wall 1121, a first side wall 1123 connecting one end of the first top wall 1121 and one end of the first bottom wall 1122, a second side wall 1124 connecting the other end of the first top wall 1121 and the other end of the first bottom wall 1122, a mating surface 1125, and a mating slot 1126 extending through the mating surface 1125 along the first direction A1. The mating slot 1126 is jointly enclosed by the first top wall 1121, the first bottom wall 1122, the first side wall 1123 and the second side wall 1124. The mating slot 1126 is configured to receive a mating module (for example, a tongue plate of a mating connector, not shown). In the illustrated embodiment of the present disclosure, a plurality of mating slots 1126 are provided and they are spaced apart along a left-right direction of the body 11.

In the illustrated embodiment of the present disclosure, the first top wall 1121 defines a plurality of first openings 1121a. The first bottom wall 1122 defines a plurality of second openings 1122a. The first openings 1121a and the second openings 1122a are in communication with the mating slot 1126. The first openings 1121a and the second openings 1122a are at least configured to dissipate heat from the cable connector 100.

The base portion 111 includes a second top wall 1111, a second bottom wall 1112 opposite to the second top wall 1111, a third side wall 1113 connecting one end of the second top wall 1111 and one end of the second bottom wall 1112, a fourth side wall 1114 connecting the other end of the second top wall 1111 and the other end of the second bottom wall 1112, an installation end surface 1115 opposite to the mating surface 1125, and a installation slot 1116 extending through the installation end surface 1115 along the second direction A2.

In the illustrated embodiment of the present disclosure, a width of the mating protrusion 112 along the left-right direction is smaller than a width of the base portion 111 along the left-right direction.

The plurality of extending protrusions 113 are disposed at intervals along the left-right direction. The body 11 further includes an installation space 114 located outside (for example, on a rear end) of the installation end surface 1115 along the second direction A2. The extending protrusion 113 defines a positioning groove 1130 in communication with the installation space 114. The built-in adapter circuit board 2 is at least partially inserted into the positioning groove 1130.

In the illustrated embodiment of the present disclosure, at least part of the extending protrusion 113 includes a first fixing hole 1131 extending upwardly through an upper side of the extending protrusion 113 along the third direction A3-A3 and a second fixing hole 1132 extending downwardly through a lower side of the extending protrusion 113 along the third direction A3-A3. In the illustrated embodiment of the present disclosure, the extending protrusion 113 further includes a first raised portion 1133 located at its rear end and protruding upwardly, and a second raised portion 1134 located at its rear end and protruding downwardly.

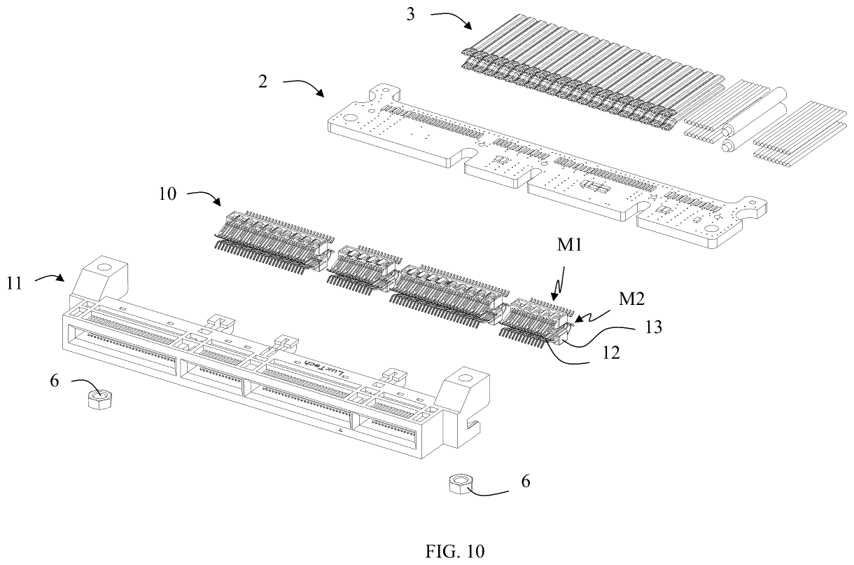

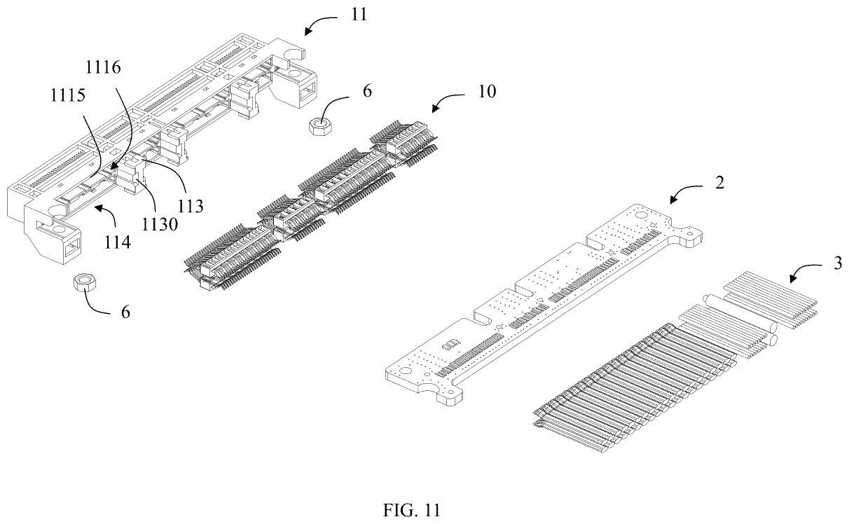

Referring to FIG. 10 to FIG. 15, the electrical connector 1 includes a plurality of terminal modules 10. Each terminal module 10 includes the plurality of conductive terminals 12 and an insulating block 13 fixing the conductive terminals 12. In the illustrated embodiment of the present disclosure, the conductive terminals 12 are insert-molded with the insulating block 13. Of course, it is understandable to those skilled in the art that the conductive terminals 12 can also be fixed to the insulating block 13 through assembly or other means. The insulation block 13 is at least partially received in the installation slot 1116.

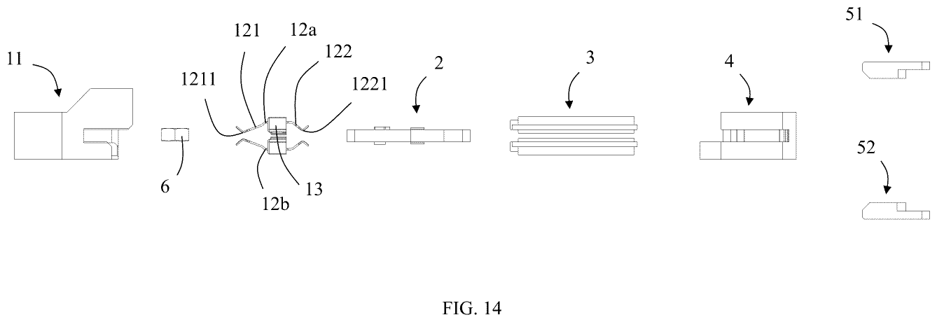

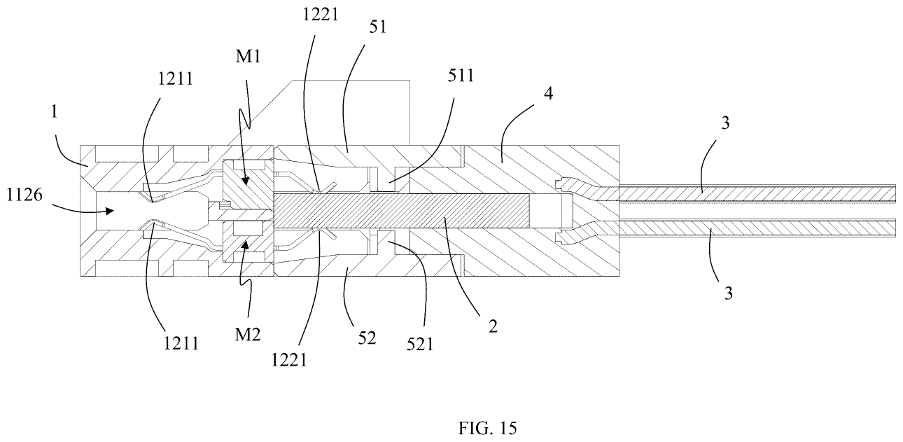

Referring to FIG. 14 and FIG. 15, in the illustrated embodiment of the present disclosure, each conductive terminal 12 includes a fixing portion fixed in the insulating block 13, a mating elastic arm 121 extending from one end (for example, a front end) of the fixing portion, and a connecting elastic arm 122 extending from another end (for example, a rear end) of the fixing portion. In the illustrated embodiment of the present disclosure, the mating elastic arm 121 and the connecting elastic arm 122 are both cantilever-shaped, and both extend and protrude beyond the insulating block 13. The mating elastic arm 121 includes a mating portion 1211 protruding into the mating slot 1126. The connecting elastic arm 122 includes a tail portion 1221 protruding into the installation space 114.

In the illustrated embodiment of the present disclosure, corresponding to the same mating slot 1126, the terminal module 10 includes a first terminal module MI (for example, an upper terminal module) and a second terminal module M2 (for example, a lower terminal module). The first terminal module MI includes a plurality of first conductive terminals 12a. The second terminal module M2 includes a plurality of second conductive terminals 12b. The first conductive terminals 12a and the second conductive terminals 12b are disposed on two sides (for example, upper and lower sides) of the mating slot 1126, respectively, along the third direction A3-A3. The tail portions 1221 of the first conductive terminals 12a and the tail portions 1221 of the second conductive terminals 12b both extend and protrude beyond the installation end surface 1115 to jointly clamp the built-in adapter circuit board 2. The third direction A3-A3 is perpendicular to the first direction A1 and the second direction A2.

In the illustrated embodiment of the present disclosure, the cable connector 100 further includes a pair of nuts 6 installed in the body 11. Each nut 6 is provided with internal threads. The nut 6 is used to cooperate with a fastening bolt (not shown) to fix the cable connector 100 to a circuit board (not shown).

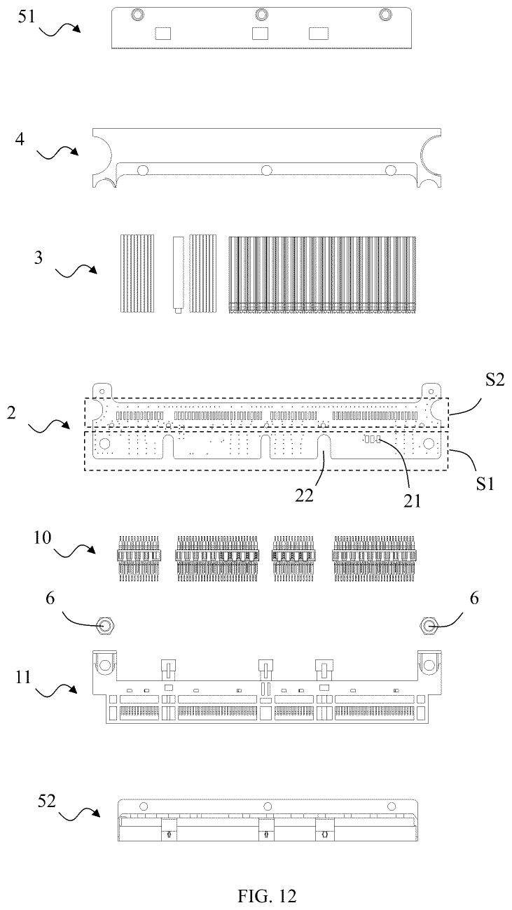

As shown in FIG. 12, the built-in adapter circuit board 2 includes a first area S1 and a second area S2. The first area S1 is electrically connected to the tail portions 1221 of the conductive terminals 12. For example, the first area S1 is provided with a plurality of conductive pads (not shown) to be fixed to the tail portions 1221 of the conductive terminals 12 by soldering or welding. Specifically, the tail portions 1221 of the first conductive terminals 12a and the tail portions 1221 of the second conductive terminals 12b jointly clamp the second area S2 of the built-in adapter circuit board 2. The first area S1 of the built-in adapter circuit board 2 is further provided with a plurality of electronic components 21 (including, but not limited to, resistors, capacitors, inductors, etc.). Some of the electronic components 21 protrude upwardly beyond an upper surface of the first area S1 and are exposed to the installation space 114. Another some of the electronic components 21 protrude downwardly from a lower surface of the first area S1 and are exposed to the installation space 114.

The second area S2 of the built-in adapter circuit board 2 is electrically connected to the cables 3. For example, the second area S2 is provided with a plurality of of pads (not shown) to be fixed to the cores of the cables 3 by soldering or welding.

The over-molding housing 4 is over-molded on the second area S2 to cover the connection position between the cables 3 and the second area S2. After being molded, the over-molding housing 4 also covers at least part of the cables 3. In the illustrated embodiment of the present disclosure, the over-molding housing 4 does not cover the first area S1 so as to prevent impact or even damage to the electronic components in the first area S1 when the over-molding housing 4 is formed.

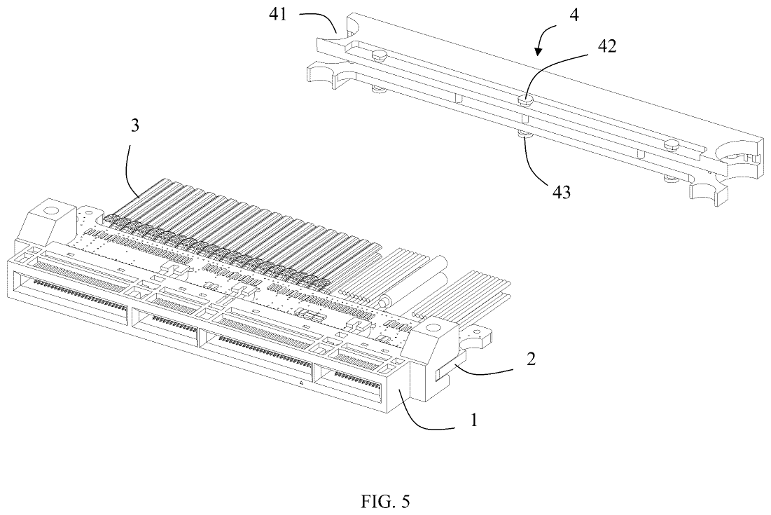

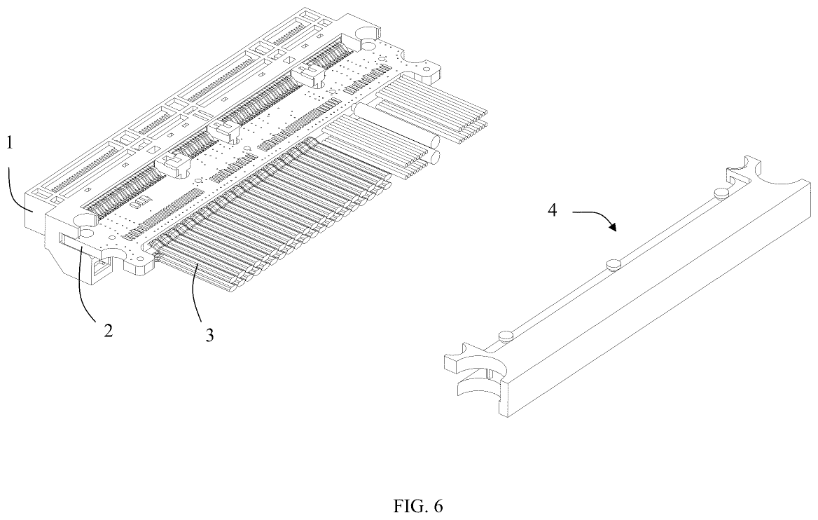

Referring to FIG. 5 and FIG. 6, in the illustrated embodiment of the present disclosure, the over-molding housing 4 includes a plurality of first fixing posts 42 extending upwardly and a plurality of second fixing posts 43 extending downwardly.

Referring to FIG. 12, in the illustrated embodiment of the present disclosure, the built-in adapter circuit board 2 further defines a relief groove 22 that mates the extending protrusion 113 to ensure that the built-in adapter circuit board 2 is installed on the body 11 at a fixed angle. In other words, the cooperation between the extending protrusion 113 and the relief groove 22 can prevent fool-proofing and prevent the built-in adapter circuit board 2 from being installed incorrectly.

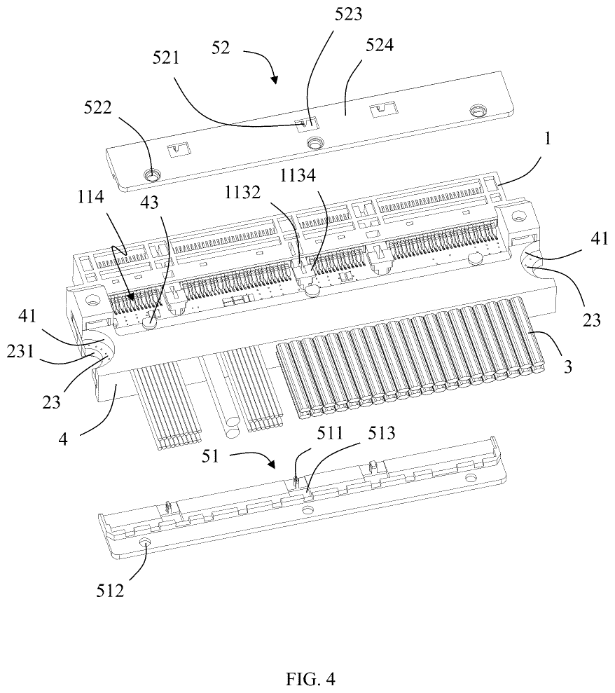

Referring to FIG. 4, in the illustrated embodiment of the present disclosure, the over-molding housing 4 defines a notch 41. The built-in adapter circuit board 2 is provided with a mounting portion 23 protruding into the notch 41. The mounting portion 23 defines a mounting recess 231. The mounting recess 231 is used for a fastener (for example, a bolt) to pass through to fix the cable connector 100.

Referring to FIG. 1 to FIG. 4, in the illustrated embodiment of the present disclosure, the cover plate 5 is an insulating cover plate. The cover plate 5 includes a first cover plate 51 and a second cover plate 52. The first cover plate 51 and the second cover plate 52 are respectively installed on the body 11 and/or the over-molding housing 4 from two sides along the third direction A3-A3 to cover two sides (for example, upper and lower sides) of the installation space 114.

Specifically, the first cover plate 51 is provided with a first fixing post 511 inserted and fixed in the first fixing hole 1131, a first through hole 512 for the first fixing post 42 to pass through, and a first positioning hole 513 for the first raised portion 1133 to pass through. The first fixing post 511 is disposed adjacent to the first through hole 512. In the illustrated embodiment of the present disclosure, the first fixing post 511 is provided with a plurality of first ribs protruding from two sides to increase the interference force with the extending protrusion 113, thereby increasing the fixing strength.

The second cover plate 52 is provided with a second fixing post 521 inserted and fixed in the second fixing hole 1132, a second through hole 522 for the second fixing post 43 to pass through, and a second positioning hole 523 for the second raised portion 1134 to pass through. The second fixing post 521 is disposed adjacent to the second through hole 522. In the illustrated embodiment of the present disclosure, the second fixing post 521 is provided with a plurality of second protruding ribs protruding from two sides to increase the interference force with the extending protrusion 113, thereby increasing the fixing strength.

When the first cover plate 51 and the second cover plate 52 are installed in place, an upper surface 514 of the first cover plate 51, the second top wall 1111 and the first top wall 1121 are flush; a lower surface 524 of the second cover plate 52, the second bottom wall 1112 and the first bottom wall 1122 are flush, so that the height of the cable connector 100 is not increased.

Compared with the prior art, the cable connector 100 of the present disclosure includes the over-molding housing 4 and the cover plate 5. The over-molding housing 4 is over-molded on the second area S2 to cover the connection position between the cables 3 and the second area S2, thereby improving the structural strength of the cable connector 100. The cover plate 5 is installed on the body 11 and/or the over-molding housing 4 along the third direction A3-A3 to cover at least one side of the installation space 114, which facilitates maintenance of a portion of the built-in adapter circuit board 2 covered by the cover plate 5 by removing the cover plate 5. Besides, the cable connector 100 of the present disclosure further avoids the problem of impedance fluctuation of the contact points caused by internal mold injection molding.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. A cable connector, comprising:
an electrical connector, the electrical connector comprising a body and a plurality of conductive terminals provided on the body, the body comprising a mating surface, an installation end surface disposed opposite to the mating surface, a mating slot extending through the mating surface along a first direction, and an installation space located outside the installation end surface along a second direction opposite to the first direction; each conductive terminal comprising a mating portion extending into the mating slot and a tail portion extending beyond the installation end surface and extending into the installation space;
a built-in adapter circuit board, the built-in adapter circuit board being at least partially installed in the installation space; the built-in adapter circuit board comprising a first area and a second area; the first area being electrically connected to the tail portions of the plurality of conductive terminals;
a plurality of cables, the plurality of cables being electrically connected to the second area;
an over-molding housing, the over-molding housing being over-molded on the second area to cover a connection position between the plurality of cables and the second area; and
a cover plate, the cover plate being installed on the body and/or the over-molding housing along a third direction so as to cover at least one side of the installation space; the third direction being perpendicular to the first direction and the second direction.

2. The cable connector according to claim 1, wherein the second area is not provided with any electronic component; the first area is provided with at least one electronic component exposed in the installation space; the cover plate does not contact the at least one electronic component along the third direction.

3. The cable connector according to claim 1, wherein the body comprises an extending protrusion protruding beyond the installation end surface along the second direction; the extending protrusion defines a positioning groove in communication with the installation space; the built-in adapter circuit board is at least partially inserted into the positioning groove.

4. The cable connector according to claim 3, wherein the extending protrusion defines a fixing hole extending through at least one side of the extending protrusion along the third direction;
the cover plate comprises a fixing post inserted and fixed in the fixing hole.

5. The cable connector according to claim 3, wherein the built-in adapter circuit board defines a relief groove that mates with the extending protrusion.

6. The cable connector according to claim 1, wherein the plurality of conductive terminals comprise a first conductive terminal and a second conductive terminal; the first conductive terminal and the second conductive terminal are located on two sides of the mating slot, respectively, along the third direction;
the tail portion of the first conductive terminal and the tail portion of the second conductive terminal are both cantilever-shaped so as to jointly clamp the second area of the built-in adapter circuit board.

7. The cable connector according to claim 1, wherein the over-molding housing comprises a fixing post; the cover plate defines a through hole through which the fixing post at least partially passes.

8. The cable connector according to claim 1, wherein the cover plate comprises a first cover plate and a second cover plate; the first cover plate and the second cover plate are installed on the body and/or the over-molding housing from two sides along the third direction so as to cover two opposite sides of the installation space.

9. The cable connector according to claim 1, wherein the over-molding housing defines a notch; the built-in adapter circuit board comprises a mounting portion protruding into the notch; the mounting portion defines a mounting recess.

10. The cable connector according to claim 1, wherein the body is an insulating body; the body comprises a base portion and a mating protrusion extending from the base portion; the mating surface is provided on the mating protrusion; the installation end surface is provided on the base portion.

11. The cable connector according to claim 1, wherein the body defines an installation slot in communication with the mating slot;
the cable connector comprises a terminal module; the terminal module comprises an insulating block and the plurality of conductive terminals which are insert-molded with the insulating block; the insulation block is received in the installation slot; each conductive terminal comprises a mating elastic arm extending beyond the insulating block and a connecting elastic arm extending beyond the insulating block; the mating elastic arm and the connecting elastic arm are both cantilever-shaped; the mating elastic arm comprises the mating portion; the connecting elastic arm comprises the tail portion.

12. The cable connector according to claim 1, wherein the cover plate is an insulating cover plate.

13. A cable connector, comprising:
an electrical connector, the electrical connector comprising a body and a plurality of conductive terminals provided on the body, the body comprising a mating surface, an installation end surface disposed opposite to the mating surface, a mating slot extending through the mating surface along a first direction, and an installation space extending along a second direction opposite to the first direction; each conductive terminal comprising a mating portion extending into the mating slot and a tail portion extending into the installation space;
a built-in adapter circuit board, the built-in adapter circuit board being at least partially installed in the installation space; the built-in adapter circuit board comprising a first area and a second area; the first area being electrically connected to the tail portions of the plurality of conductive terminals;
a plurality of cables, the plurality of cables being electrically connected to the second area;
an over-molding housing, the over-molding housing being over-molded on the second area to cover a connection position between the plurality of cables and the second area; and
a cover plate, the cover plate being detachably installed on the body and/or the over-molding housing along a third direction so as to cover at least one side of the installation space;
the third direction being perpendicular to the first direction and the second direction.

14. The cable connector according to claim 13, wherein the second area is not provided with any electronic component; the first area is provided with at least one electronic component exposed in the installation space; the cover plate does not contact the at least one electronic component along the third direction.

15. The cable connector according to claim 13, wherein the body comprises an extending protrusion protruding beyond the installation end surface along the second direction; the extending protrusion defines a positioning groove in communication with the installation space; the built-in adapter circuit board is at least partially inserted into the positioning groove.

16. The cable connector according to claim 15, wherein the extending protrusion defines a fixing hole extending through at least one side of the extending protrusion along the third direction;
the cover plate comprises a fixing post inserted and fixed in the fixing hole.

17. The cable connector according to claim 15, wherein the built-in adapter circuit board defines a relief groove that mates with the extending protrusion.

18. The cable connector according to claim 13, wherein the plurality of conductive terminals comprise a first conductive terminal and a second conductive terminal; the first conductive terminal and the second conductive terminal are located on two sides of the mating slot, respectively, along the third direction;
the tail portion of the first conductive terminal and the tail portion of the second conductive terminal are both cantilever-shaped so as to jointly clamp the second area of the built-in adapter circuit board.

19. The cable connector according to claim 13, wherein the over-molding housing comprises a fixing post; the cover plate defines a through hole through which the fixing post at least partially passes.

20. The cable connector according to claim 13, wherein the cover plate comprises a first cover plate and a second cover plate; the first cover plate and the second cover plate are installed on the body and/or the over-molding housing from two sides along the third direction so as to cover two opposite sides of the installation space.
